(19) United States
(12) Patent Application Publication
(10) Pub. No.: US 2024/0151392 A1
(43) Pub. Date: May 9, 2024

(54) CANDLE HOLDER

(71) Applicant: Matthew Silverman, New York, NY (US)

(72) Inventor: Matthew Silverman, New York, NY (US)

(21) Appl. No.: 17/980,953

(22) Filed: Nov. 4, 2022

(51) Int. Cl. F21V 35/00

(52) U.S. Cl. CPC F21V 35/006; F21V 29/15

(57) ABSTRACT

A candle holder, comprising: a main body having a holder sized to fit a candle, and a series of openings and channels connected to the holder, wherein the openings and channels exit the main body at various locations throughout the main body.

### BACKGROUND OF THE INVENTION

The present invention relates to candle holders, and more particularly to a candle holder that is designed for the wax to drip in a way to increase the aesthetics of the candle while burning.

The problems associated with dripping candles, complete burning and effective candle mounting are well recognized and there have been numerous attempts, over more than one hundred years, to provide both practical and aesthetically attractive solutions. However, most candle holders, the wax either drips down the candle and onto the holder or the surface and follows a linear path and does not provide for any aesthetically attractive look but does create a mess that is both difficult to clean up and not the intended purpose of the candle holder.

It is desired to have a candle holder that is designed so that when the candle melts, the wax drips through various openings and channels within the candle holder to create an aesthetically pleasing wax formation and a controlled formation of the wax.

### SUMMARY

Accordingly, the present invention, may be comprised of a candle holder, comprising: a main body having a holder sized to fit a candle, and a series of openings and channels connected to the holder, wherein the openings and channels exit the main body at various locations throughout the main body.

### BRIEF DESCRIPTION OF THE DRAWINGS

FIG. 1 depicts an isometric view of a candle holder, in accordance with one embodiment of the present invention.

FIG. 2 depicts an isometric view of the candle holder, in accordance with one embodiment of the present invention.

FIG. 3 depicts a section view of the candle holder, in accordance with one embodiment of the present invention.

### DETAILED DESCRIPTION OF THE INVENTION

The present invention provides a candle holder is which designed so that as the candle melts, the wax passes through the openings and gaps within the candle holder to create a visually pleasing design with the dripping wax and the candle holder, while also providing a safe and securing mount for the candle to be placed in as it burns.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

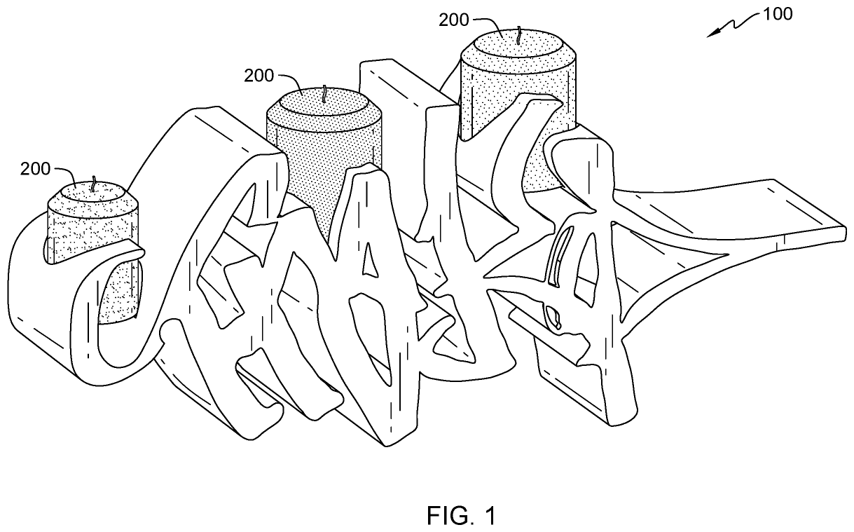

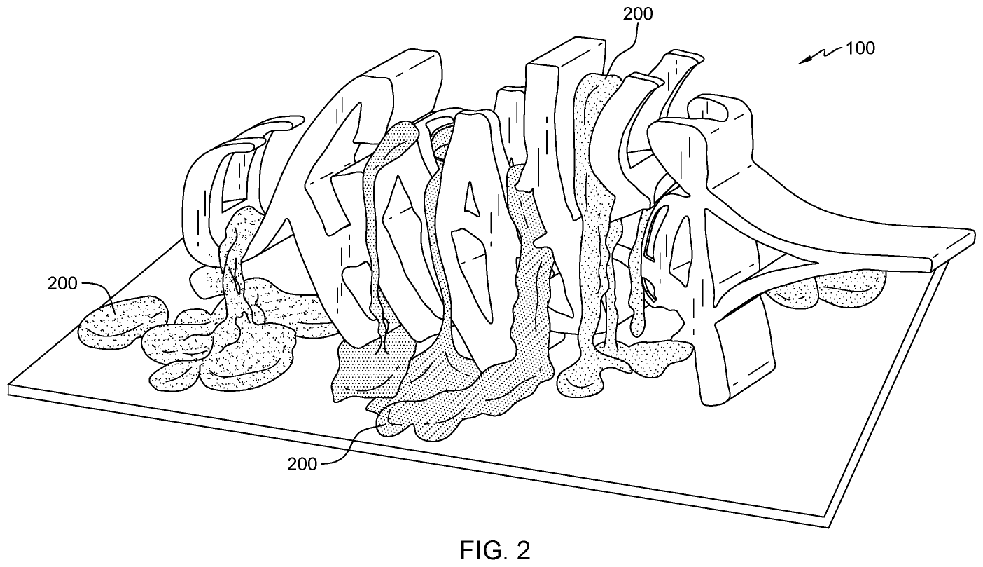

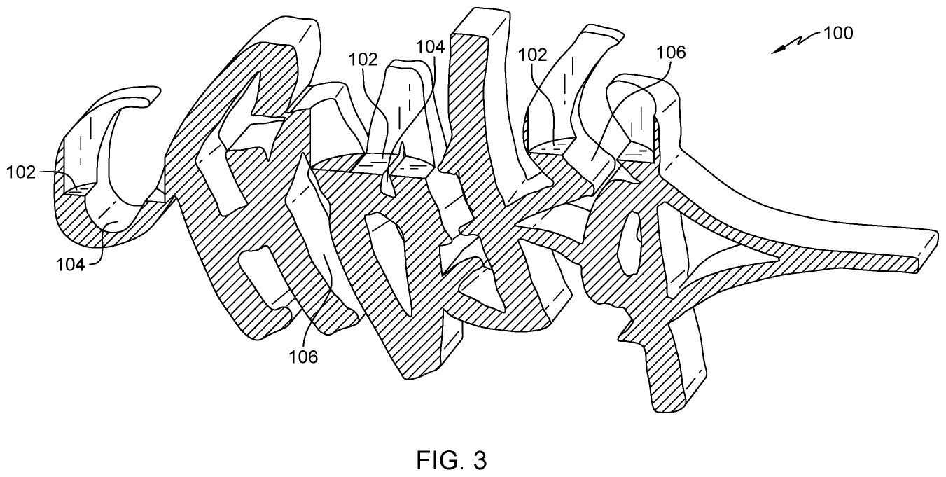

FIGS. 1-3 depicts a candle holder 100 in various stages of the burning process of the candle, in accordance with one embodiment of the present invention. The candle holder 100 is made from a heat resistant non-flammable material. The material has a smooth surface in which melted wax is able to freely flow across the surface of the candle holder 100, but also is easily removed from the candle holder 100. The candle holder 100 may be made from, but not limited to polyethylene, polyethylene terephthalate, high-density polyethylene, polypropylene, polystyrene, polyvinyl chloride, polyurethane, poly carbonate, polybutylene terephthalate, acrylonitrile styrene acrylate, acrylics, aluminum, steel, cooper, various other metals, a combination of plastics and metals, or the like. In the depicted embodiment, the candle holder 100 is a single unitary piece. In additional embodiments, the candle holder 100 is made from two or more pieces which are secured together. This provides an advantage of allowing the interior of the candle holder 100 to be easier to access and thus clean.

The candle holder 100 may have various shapes and designs provided they achieve the overall function of the candle holder 100, wherein the candle wax as it begins to melt and flow from the candle is able to travel through various cracks, openings, channels, crevices, or the like built into the candle holder 100 connected to the candle cups 102 and also exit the candle holder 100 to create an aesthetically pleasing look. In the depicted embodiment, the candle holder 100 has a cup 102 which is where a candle 200 is placed. The cup 102 provides a secure location for the candle 200 to sit and hold the candle 200 in place to reduce the opportunity for the fire to spread. Integrated into the cup 102 are various openings 104 and channel 106 entrances which are interconnected with the cup 102, so as the candle 200 melts and the wax is displaced from the candle 200, and travels through the openings 104 or channels 106 and flow through the respective opening 104 or channel 106 and exit the candle holder 100 at the respective exit. These openings 104 and channels 106, may be cracks, crevices and the like which melted wax can travel through and between with the purpose of exiting the candle holder 100 as shown in the figures. The width, length and the overall design of the channels is based on the overall design of the candle holder 100, as the depicted embodiments show one candle holder design. However, any candle holder 100 design can have the channels 106 and openings 104 designed into them. These channels 106 can be interconnected so that the candle wax from multiple candles may mix together as it exits the candle holder 100. Given that the openings 104 and the channels 106 are positioned below the cup, and extend downward and away from the cup 102, the wax travels through the candle holder 100, exiting at various spots in the candle holder 100 to create an aesthetically pleasing design when the candle 200 finally burns out. The wax is gravity fed through the candle holder 100. Given that every candle burns in a slightly different way, the wax drips in different directions even with the same candle type, and the like. The final look of the candle holder 100 once the candle is burned out will rarely if ever look the same. The length of the openings 104 and the channels 106 are based on the size of the candle holder 100 so that the wax is able to travel through the opening 104 or channel 106 and exit the candle holder 100. Given that the wax is gravity feed through the channels 106, the channels 106 are designed and positioned to allow for the gravity feeding of the wax through the channels 106.

As the wax flows through the openings 104 and the channels 106, the wax solidified and hardens, which may in turn block or close that opening 104 or channel 106. The flow of wax will then be forced to travel through a different opening 104 or channel 106 given the interconnecting of the channels 106.

In some embodiments, the candle holder 100 may have more than one cup 102, where the openings 104 and the channels 106 may be interconnected to multiple cups 102, so that the opportunity for the wax to travel through a variety of openings 104 or channels 106 is possible. There is no limit to the number of channels 106 which can be connected to one cup 102 or interconnected with other channels 106.

In additional embodiments, a candle base may be used to raise the height of the candle 200 from the cup 102. This provides for an increased flow of the melted wax through the candle holder 100 based on the accelerated speed at which it will travel. A candle mat may be placed under the candle holder 100 and have an angled or tilt to further assist the wax in traveling out of the candle in a predetermined direction based on the shape and design of the candle mat. The mat is used to assist the natural flow of the candle wax through the candle holder 100 by tilting the candle forwards or backwards to create a greater slope for the wax to travel through. In some embodiments, the candle holder 100 is secured to the mat so that the candle holder 100 does not tip or fall over. The mat may also have a lip or a raised edge to keep the candle wax contained.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A candle holder, comprising:
a main body having a holder sized to fit a candle, and a series of openings and channels connected to the holder, wherein the openings and channels exit the main body at various locations throughout the main body.

2. The candle holder of claim 1, wherein the main body has at least two holders, wherein the series of openings and channels are interconnected to the at least two holders.

3. The candle holder of claim 1, wherein the main body is made from a heat resistance material.

4. The candle holder of claim 1, wherein the main body is made of a smooth material, wherein candle wax does is easily removed from the main body surface.

5. The candle holder of claim 1, wherein each holder has at least one opening connected to at least one channel.

6. The candle holder of claim 1, wherein the main body is comprised of two or more parts which are interconnected.

7. A candle holder, comprising:
a main body comprised of at least two interconnecting parts, wherein the main body having at least one opening sized to fit a candle, and a series of channels extending from the opening, wherein the channels are interconnected and extend through the main body and have openings at various locations throughout the main body.

8. The candle holder of claim 7, wherein the main body is made from a heat resistance material.

9. The candle holder of claim 7, wherein the main body is made of a smooth material, wherein candle wax does is easily removed from the main body surface.

10. The candle holder of claim 7, further comprising, a mat placed underneath the candle holder, wherein the mat has a predetermined tilt.

11. The candle holder of claim 10, wherein the candle holder is detachably secured to the mat.

12. The candle holder of claim 10, wherein the mat has a raised edge.
